(19) United States
(12) Patent Application Publication
(10) Pub. No.: US 2008/0085617 A1
(43) Pub. Date: Apr. 10, 2008

(54) Headset charger

(76) Inventor: JoeBen Bevirt, Santa Cruz, CA (US)

Correspondence Address: MICHAEL A. GUTH, 2-2905 EAST CLIFF DRIVE, SANTA CRUZ, CA, 95062, US

(21) Appl. No.: 11/599,153

(22) Filed: Nov. 13, 2006

Related U.S. Application Data
(60) Provisional application No. 60/849,554, filed on Oct. 4, 2006.

(51) Int. Cl. H01R 29/00; H01R 4/58

(52) U.S. Cl. 439/104; 439/170

(57) ABSTRACT

A charging unit for an electrical device such as a headset. The charging unit is designed to minimize the envelope of the unit when the outlet interface prongs are in the stowed position. The charging unit minimizes the use of space when plugged into an outlet or into an outlet strip. A kit including a charging unit, an coupler adapted to hard mount a headset to the charging unit while charging, and a power cord adapted to connect to a headset to charge the headset while the headset is at a position further from the charging unit.

### CROSS-REFERENCE TO RELATED APPLICATIONS

This application claims priority to provisional Patent Application No. 60/849,554 to Bevirt et al., filed Oct. 4, 2006.

### BACKGROUND

1. Field of the Invention

The present invention relates to electronics, and specifically to a charging unit and system.

2. Description of Related Art

A headset may be used in conjunction with a telephone device for several reasons. With a headset, the user is relieved of the need to hold the phone and thus retains his or her hands free to perform other functions. Headsets also function to position the earphone and microphone portions of a telephone close to the user's head to provide for clearer reception and transmission of audio signals with less interference from background noise. Headsets may be used with telephones, computers, cellular telephones, and other devices.

With a mobile device such as a headset or a cellular phone there is an increased need for compactness, portability, and durability. Headsets are used more and more by business travelers as well. A charging unit for the electronic devices is typically brought along with the unit when the user travels. A user may not desire to bring a cable along due to space concerns. The user may also desire to have the unit to be charged hard mounted onto the charger on a wall outlet and out of harm's way.

However, in other uses, the user may desire to use a cord with the charger, perhaps leaving the headset on a desk or nightstand. In many office environments, and also homes, there may be many electronic devices. Typically, an outlet strip is used to distribute power. Charger units and transformers typically are somewhat bulky and may overlay another outlet on the outlet strip besides the one being plugged into.

What is called for is a single charging unit that meets a user's need for compactness, the use of a power cord with the charger or hard mounting of the device to the charger, and also that does not occupy extra space on a power strip.

### SUMMARY

A charging unit for an electrical device such as a headset. The charging unit is designed to minimize the envelope of the unit when the outlet interface prongs are in the stowed position. The charging unit minimizes the use of space when plugged into an outlet or into an outlet strip. A kit including a charging unit, a coupler adapted to hard mount a headset to the charging unit while charging, and a power cord adapted to connect to a headset to charge the headset while the headset is at a position further from the charging unit.

### BRIEF DESCRIPTION OF THE DRAWINGS

FIGS. 1A-B are perspective views of a charger in the deployed position according to some embodiments of the present invention.

FIGS. 2A-C are orthographic views of a charger in the deployed position according to some embodiments of the present invention.

FIGS. 3A-B are perspective views of a charger in the stowed position according to some embodiments of the present invention.

FIGS. 4A-C are orthographic views of a charger in the stowed position according to some embodiments of the present invention.

FIG. 5 is an illustration of a charging system according to some embodiments of the present invention.

FIG. 6 is an illustration of a charging system according to some embodiments of the present invention.

FIG. 7 is an illustration of a charging unit and a power strip according to some embodiments of the present invention.

### DETAILED DESCRIPTION

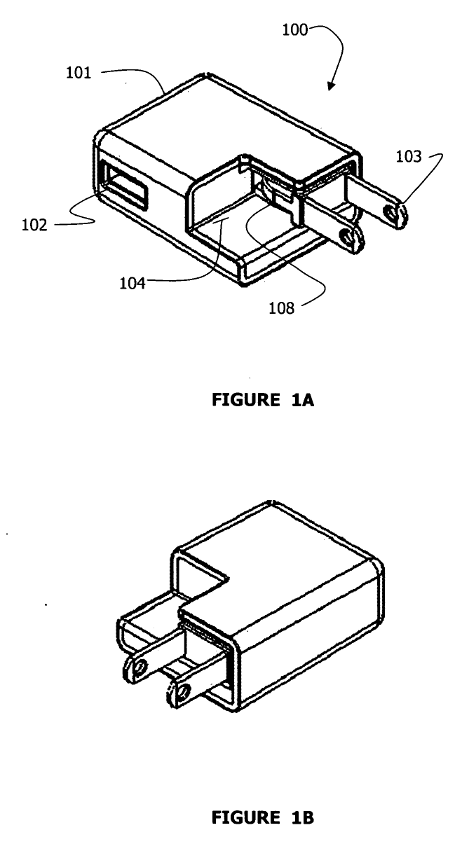

In some embodiments of the present invention, as seen in FIGS. 1A-B and 2A-B, a charging unit 100 is adapted for efficiency of design with regard to space. The main body 101 of the charger is a substantially rectangular unit of reduced thickness. The outlet interface plugs 103 are seen rotatably attached to the main body 101 with a rotating plug unit 108. The rotating plug unit may be of a design such that electrical continuity from the outlet interface plugs 103 to the electronics within the main body 101 is maintained only when the plugs are in their fully deployed position. A recess 104 is seen in the base surface 105 of the main body 101.

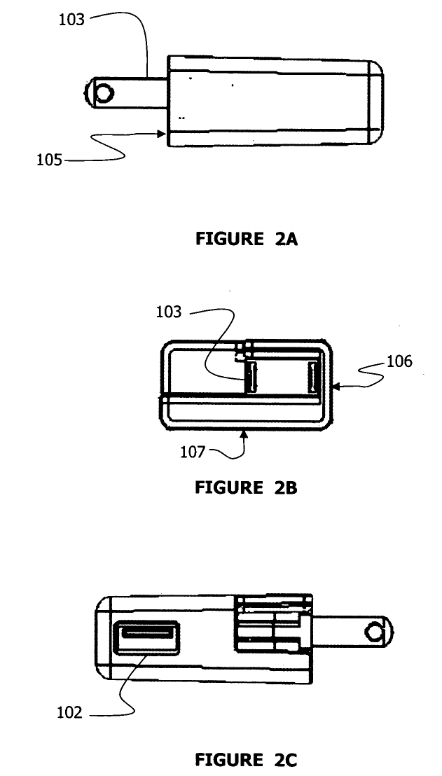

In some embodiments; as seen in FIG. 2B, the plugs 103 are in very close proximity to the side surface 106 of the main body 101 when viewed from the base surface. The side surface 106 may have a dimension of approximately 1 inch in some embodiments. As seen, the width 107 of the main body may be as small as approximately twice the width of a conventional set of outlet plugs. The width 107 of the main body 101 may be approximately 2 inches in some embodiments. The height of the side surface 106 may be as little as the width of a conventional set of outlet plugs as well.

An outlet port 102 is adapted to receive a standard USB type connector in some embodiments. The connector is used to route charge to the unit being charged. In some uses a male to male adapter from standard to mini-USB may be inserted into the outlet port 102 and the device may be hard mounted to the charger. In other embodiments, a USB cable may be inserted into the outlet port 102 and routed to the device, which may be a headset in some embodiments. Thus, the charger is adapted to allow for a compact hard mounting of the device, or the use of a cable, depending upon the desires of the user.

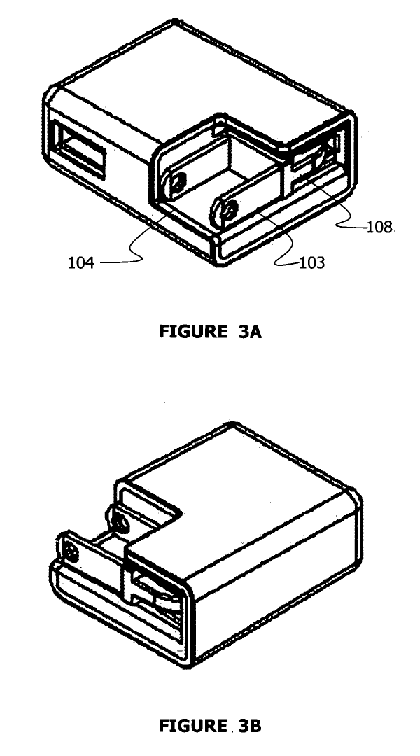

FIGS. 3A-B and 4A-C illustrate a charging unit 100 with its prongs in the stowed position according to some embodiments of the present invention. The prongs 103 have been rotated 90 degrees from the deployed position to the stowed position. The plugs 103 rest in the recess 104 when stowed. The plugs 103 are stowed via the rotation of the rotating plug unit 108.

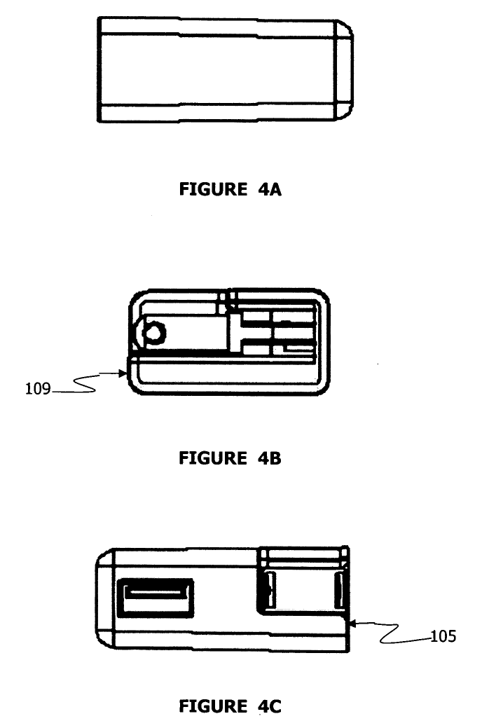

In some embodiments, as seen in FIG. 4C, the prongs 103, or the rotating plug unit 108, do not protrude beyond the base surface 105 when the plugs 103 are stowed. Also, the plugs 103 do not protrude beyond the side surface 109 of the main body 101 when stowed. This protected position of the plugs 103 when stowed minimizes the risk of damage to the unit.

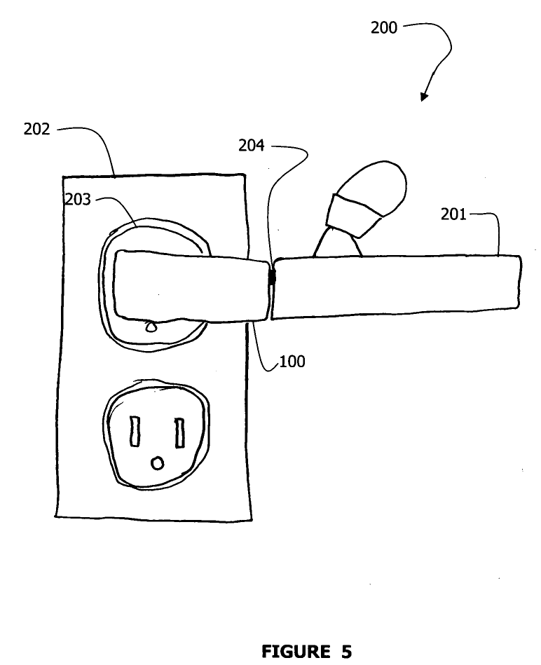

FIG. 5 is an illustration of a charging system 200 according to some embodiments of the present invention. The charging unit 100 is seen plugged into the plug 203 of a wall outlet 202. A headset 201 is hard mounted to the charging unit 100 with an adapter 204. The charging system 200 allows for the compact wall mounting of an electronic device, such as a wireless headset, while being charged. In some embodiments, the headset 201 has a miniature USB port adapted to receive the power charge from the charger. In some embodiments, the charger has a standard USB port adapted to deliver the power charge. The adapter 204 may be a male-male mini-USB to USB adapter in some embodiments.

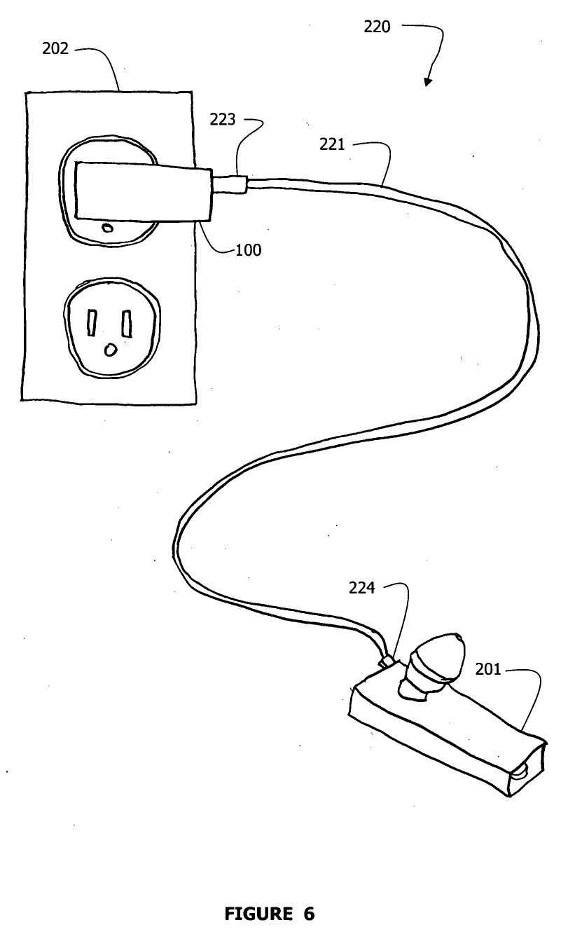

FIG. 6 is an illustration of a charging system 220 according to some embodiments of the present invention. The charging unit 100 is seen plugged into the plug 203 of a wall outlet 202. A removable power cord 221 is seen plugged into the charging unit 100 on a first end and into a headset 201 on a second end. The power cord 221 may have a USB plug 223 on its first end and a mini-USB plug on its second end in some embodiments. The use of the charging system 220 using a power cord 221 allows the use of the same charging unit 100 as seen in the hard mounted embodiment above.

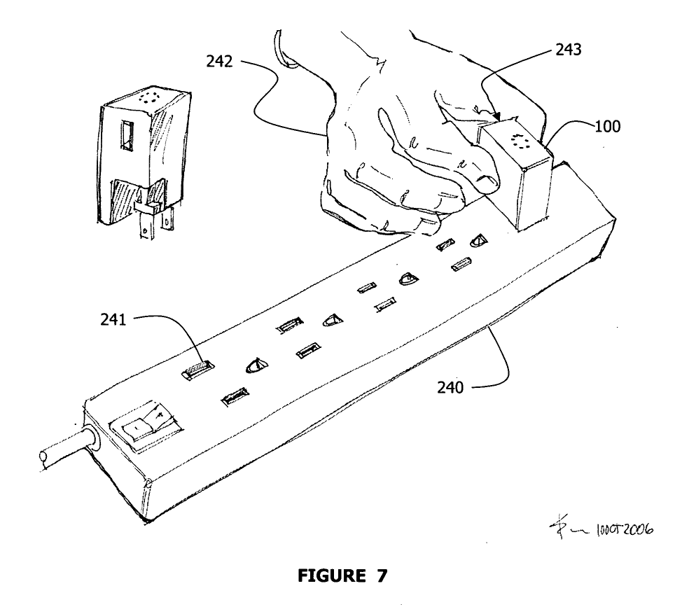

FIG. 7 illustrates a charging unit and a power strip according to some embodiments of the present invention. The power strip 240 is seen with multiple outlets 241. The user's hand 242 is seen plugging in a charging unit 100 into an outlet. As seen, the charging unit does not overlap any of the other outlets. The region 243 wherein the adapter or power cord will be plugged into the charging unit 10 also does not interfere with access to any of the other outlets.

As evident from the above description, a wide variety of embodiments may be configured from the description given herein and additional advantages and modifications will readily occur to those skilled in the art. The invention in its broader aspects is, therefore, not limited to the specific details, representative apparatus and illustrative examples shown and described. Accordingly, departures from such details may be made without departing from the spirit or scope of the applicant's general inventive concept.

I claim:

1. A charging unit comprising:
a main body, said main body comprising:
a base surface;
a plug unit, said plug unit comprising plugs adapted for plugging into a power outlet, said plug unit rotatably coupled to said main body; and
a recess in said main body along said base surface, wherein said plug unit is adapted to rotate from deployed position substantially perpendicular to said base surface to a stowed position substantially within said recess.

2. The charging unit of claim 1 wherein said base surface comprises a first side substantially parallel to the rotation axis of said plug unit, wherein said plug unit is directly adjacent to said first side of said base surface.

3. The charging unit of claim 2 wherein said base surface further comprises a second side, substantially perpendicular to the rotation axis of said plug unit.

4. The charging unit of claim 3 wherein said second side is approximately twice the width of said plug unit.

5. The charging unit of claim 4 wherein said plug unit is approximately one inch wide.

6. The charging unit of claim 3 wherein said base surface further comprises a third side, said third side opposite and substantially parallel to said first side, wherein said plugs are directly adjacent to said third side when said plug unit is in its stowed position.

7. The charging unit of claim 6 wherein said main body further comprises a power port, said power port adapted to route power to an electronic device.

8. The charging unit of claim 7 wherein said power port faces a direction substantially perpendicular to the rotation axis of said plug unit.

9. The charging unit of claim 8 wherein said power port is a standard USB port.

10. A system comprising:
a charging unit, said charging unit comprising:
a main body, said main body comprising:
a base surface;
a plug unit, said plug unit comprising plugs adapted for plugging into a power outlet, said plug unit rotatably coupled to said main body; and
a recess in said main body along said base surface, wherein said plug unit is adapted to rotate from deployed position substantially perpendicular to said base surface to a stowed position substantially within said recess;
a wireless headset, and
a coupler, said coupler adapted to rigidly couple said wireless headset to said charging unit, said coupler adapted to electronically couple said wireless headset to said charging unit.

11. The system of claim 10 wherein said base surface comprises a first side substantially parallel to the rotation axis of said plug unit, wherein said plug unit is directly adjacent to said first side of said base surface.

12. The system of claim 11 wherein said main body further comprises a power outlet port, said power port adapted to route power to an electronic device, wherein said power port faces a direction substantially perpendicular to the rotation axis of said plug unit.

13. A kit comprising:
a charging unit, said charging unit comprising:
a main body, said main body comprising:
a base surface;
a plug unit, said plug unit comprising plugs adapted for plugging into a power outlet, said plug unit rotatably coupled to said main body; and
a power port, said power port adapted to route power to an electronic device;
a coupler, said coupler adapted to rigidly couple a wireless headset to said charging unit, said coupler adapted to electronically couple a wireless headset to said charging unit; and
a power cord, said power cord adapted to plug into said power port at a first end, said power cord adapted to plug into a wireless headset at a second end.

14. The kit of claim 13 further comprising a wireless headset.

15. The kit of claim 13 wherein said base surface comprises a first side substantially parallel to the rotation axis of said plug unit, wherein said plug unit is directly adjacent to said first side of said base surface.
